(19) United States
(12) Patent Application Publication
(10) Pub. No.: US 2006/0155716 A1
(43) Pub. Date: Jul. 13, 2006

(54) Schema change governance for identity store

(75) Inventors: Karan Vasishth, Redmond, WA (US); Kimberley Ann Hunter, Snoqualmie, WA (US); Laurie A. Brown, Stanwood, WA (US); Mark David Lawrence, Duvall, WA (US); Matthias Leibmann, Woodinville, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/021,745

(22) Filed: Dec. 23, 2004

(51) Int. Cl. G06F 17/30

(52) U.S. Cl. 707/100

(57) ABSTRACT

A system includes a schema defining terms for objects in an identity store, and a schema governance module controlling changes to the schema based on schema change criteria. A method of managing an existing schema defining objects in an identity store includes receiving a request specifying a proposed change to the existing schema, and determining whether to approve the proposed schema change based on schema change criteria.

### CROSS-REFERENCE TO RELATED APPLICATIONS

The present application is related to concurrently filed U.S. patent application Ser. No. ______ entitled “SYSTEMS AND PROCESSES FOR FACILITATING POLICY CHANGE”, U.S. patent application Ser. No. ______ entitled “SELF-HEALING IN AN IDENTITY SYSTEM”, and U.S. patent application Ser. No. ______ entitled “ELEVATED PRIVILEGES IN AN IDENTITY SYSTEM”, which are assigned to the Assignee of the present application, and incorporated herein by reference for all that they disclose.

### BACKGROUND

Corporations and other organizations typically include a network and identity repository for keeping track of organizational resources. For example, a directory can be used to store data that represents computers, employees, user accounts, application programs and other real-world entities, so that such organizational entities can be identified, tracked and managed. In large corporations, identity information may be distributed across many systems. The manner in which the identity information is defined is important to ensure effective, efficient, stable and secure day-to-day operations.

A schema is one way to define the vocabulary of identity information in the identity store. A schema is a structural model that defines how objects in the real world, such as people and computers, are represented in the identity store. The schema may define the structure of the identity store, the names of the objects in it, and the attributes of those objects. An attribute holds values that may need to conform to a particular syntax or range of values.

When objects or attributes are to be added to or changed in the identity store, the schema must be updated with the new or changed definitions. The changes are typically implemented across systems in an enterprise. Thus, changes to the schema effect how users interact with the network resources and information. For example, a new application can require defining new schema attributes on user objects, to enable user access to the application or user description for the application. These attributes are the extended definition of terms which allow the users to take advantage of the application functionality.

Because a change to the schema can have such a drastic impact on how users access resources, many users simply avoid changing the schema and “make due” with the current schema definitions. Users may perform inefficient “workarounds” to perform day-to-day tasks, rather than changing the schema in a way that could make their jobs more efficient or effective. A change to the schema can be in conflict with an existing definition. In addition, changes can duplicate already existing definitions, resulting in confusion and information clutter. Duplicated definitions can also result in users being required to enter the same information multiple times in various network access situations. Furthermore, once a schema change is made, the change can be very difficult to remove.

As such, much of the value in schemas for use with identity stores has not been realized using existing approaches.

Thus, there is a need for a way to more effectively manage schemas for identity stores so that the value of schemas can be more fully realized.

### SUMMARY

Implementations described herein provide processes and systems for governing changes to a schema for an identity store. A process requires a user who is proposing a schema change to test the schema change prior to submitting the request. The user then submits information describing the proposed schema change. The process receives the proposed schema change information and analyzes the change based on schema change approval criteria. The proposed schema change is analyzed with respect to the current schema and any other proposed schema changes. If the schema change meets requirements of the schema change approval criteria, the change is implemented.

### BRIEF DESCRIPTION OF THE FIGURES

FIG. 1A illustrates an exemplary system for managing changes to a schema related to an identity store;

FIG. 1B illustrates an exemplary schema;

FIG. 2 illustrates an exemplary algorithm for governing changes to a schema;

FIG. 3 illustrates an exemplary algorithm for analyzing a proposed schema change to determine whether to approve or reject the proposed change;

FIG. 4 illustrates an exemplary algorithm for deploying a schema with an approved change;

FIG. 5 illustrates a general purpose computer that can be used to implement the exemplary schema change governance processes and systems described herein.

### DETAILED DESCRIPTION

An identity system includes identity data representing real-world entities relevant to a corporation, or other organization. Real-world entities include, but are not limited to, human users, user accounts, resources, role, files, application programs, computers, and network appliances. The identity system enables the organization to, at a minimum, identify the real-world entities and maintain attribute information descriptive of the real-world entities. Preferably, the identity system also allows for higher-level functions, such as, secure access to, and tracking use of, the real-world entities.

The identity data can be embodied as one or more objects, wherein each object represents a real-world entity. A data dictionary defines the terms or attributes that characterize the objects. For example, a user object may be characterized by a first name, a surname, a title, a location, and so on. The data dictionary can be embodied in a schema. The schema can be in the form of a template that can be extended, added to, or edited, to change the definition of objects in the identity store.

A real-world event can affect real-world entities, and thus the associated objects, identified in the identity system. As a result an object may need to change to accurately reflect changes related to the associated real-world entity. A change to the object typically must be reflected in the schema. For example, an attribute added to the schema is applied to an object class, and thus, applied to all objects in that class (e.g. user objects). Because schemas tend to be fundamental to an identity system, a change to a schema can cause serious problems in the identity system, if the change is not governed properly.

Described herein are various implementations of systems and methods for governing changes to a schema associated with an identity store. In accordance with various implementations described herein, an identity system includes a schema governance module that oversees a proposed change to a schema and allows and/or denies the proposed change based on the effect of the proposed change. Generally, when a proposed schema change is not in accordance with schema change criteria, the proposed schema change is rejected. Conversely, when a proposed schema change is in accordance with schema change criteria, the proposed schema change is approved.

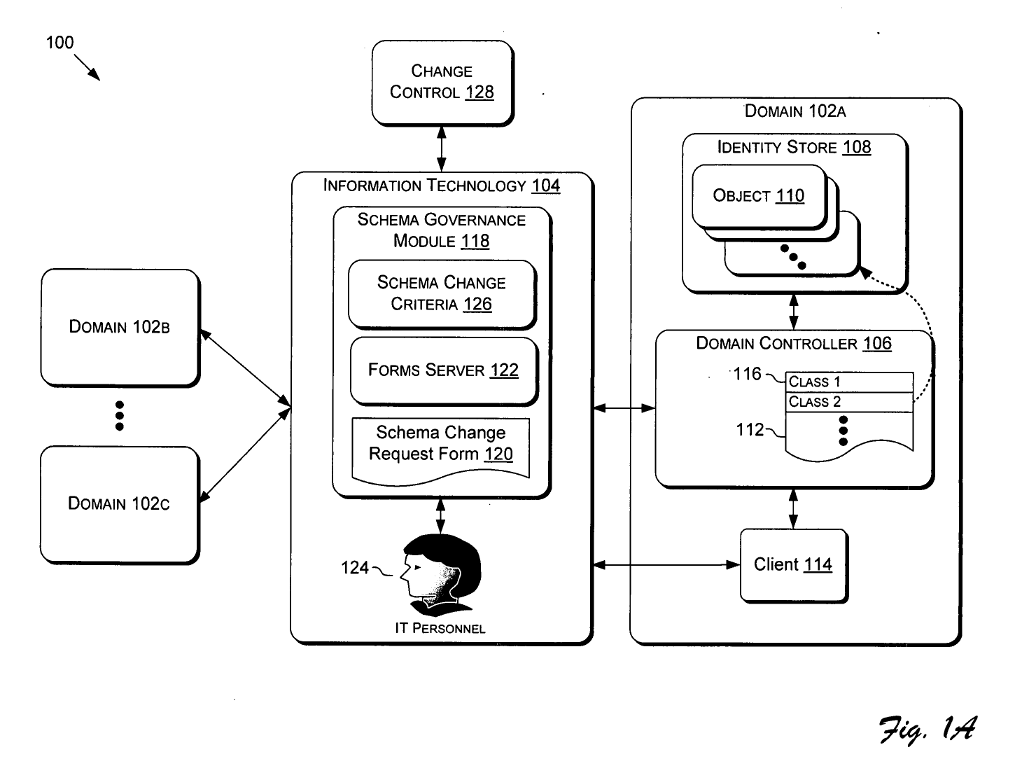

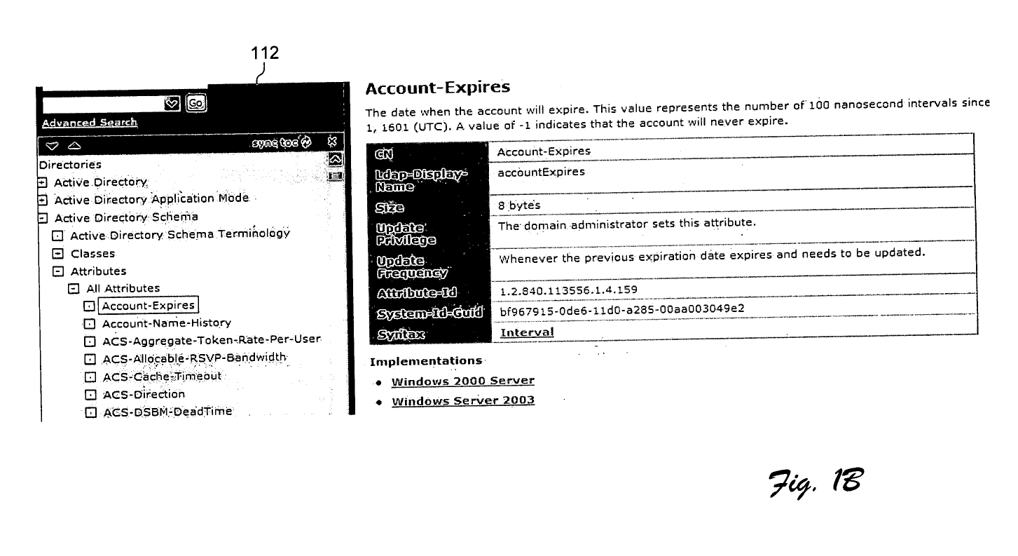

FIG. 1A illustrates an exemplary identity system 100 in which a number of domains 102a, 102b, 102c, interact with an information technology (IT) system 104 to manage schemas that define identity data within the system 100. Each domain 102a, 102b, 102c includes one or more users who use the identity data to perform tasks, such as logon to a user account, access network-based resources, and so on. The identity data is described by one or more schemas, which defines vocabulary relevant to the identity data. The system 100 employs various processes for managing or governing the manner of changing the schema.

As shown in FIG. 1A, various components of domain 102a are illustrated. Domain 102b and 102c have similar components. More specifically, domain 102a includes a domain controller 106 and an identity store 108. The identity store 108 stores identity data related to the domain 102a. As shown, the identity data is embodied in one or more objects 110 that represent real-world entities. Real-world entities can include, but are not limited to, users, user accounts, application programs, computers, printers, or network appliances. The domain controller 106 uses a schema 112 to define the objects 110. The schema 112 and the identity store 108 are typically stored in a database or other memory that is accessible by the domain controller 106.

The domain 102a includes one or more entities, including, for example, a client 114. The client 114 typically performs various activities, such as logging into an account, accessing and using network-based resources, communicating with other entities, and so on. The client 114 communicates with the domain controller 106 to perform these activities. The domain controller 106 controls whether and how the client 114 can perform the activities, based on objects 110 in the identity store 108.

Thus, for example, when the client 114 logs on to a user account, the domain controller determines whether the client's 114 username and password correspond to the proper username and password a user object in the identity store 108. As another example, the domain controller 106 determines whether the client 114 is authorized to access a requested resource based on authorization information included in a user object in the identity store 108.

FIG. 1B illustrates an exemplary schema 112. The schema 112 is a template of one or more classes 116 that sets forth the structural model that defines how entities in the real world, such as people and computers, are represented in the identity store 108. The schema 112 may define the structure of the identity store 108, the naming convention of the objects 110 in it, and the attributes of those objects 110. An attribute holds values that may need to conform to a particular syntax or range of values. The classes 116 define vocabulary used to define attributes of the objects 110. Thus, for example, a class 114 may specify that a password shall be at least eight characters long and be a complex password.

In one implementation, the each domain 102a, 102b, and 102c is an ACTIVE DIRECTORY, a software platform from MICROSOFT CORPORATION. ACTIVE DIRECTORY is a directory service that lets organizations efficiently share and manage information about network entities. In ACTIVE DIRECTORY, one or more domains can be included in a forest. Generally, a forest defines a security boundary around a related set of domains. A domain is a collection of computers defined by the administrator of a network. These computers share a common directory database, security policies and security relationships with other domains. By way of example, but not limitation, one forest can relate to a corporate network, while another forest can relate to a software development network.

The information technology system 104 includes a schema governance module 118 for controlling changes to the schema 112. Change to a schema include, but are not limited to, extensions to the schema, addition of classes or attributes, deletion of classes or attributes, or changes to the syntax or format of a class or attribute. For example, the client 114 may want an object 110 to be defined in a different way; e.g., have more or fewer attributes, attribute with a different format, etc. The schema governance module 118 provides a schema change request form 120 that can be used by the client 114 to request the desired change to the schema 112. The schema change request form 120 typically includes a number of fields or questions, that, when filled in and answered by the client 114, describe the requested change.

The schema change request form 120 can be in any format suitable to the particular system 100. For example, in some implementations, the client 114 is not aware of the schema 112, or that the schema 112 must be changed in order to carry out a desired change. In this case the schema change request form 120 does not refer to the schema 112 specifically, but rather enables the client 114 to describe the proposed change in words. In cases where the client 114 is familiar with the schema 112, the schema change request form 120 may enable the client 114 to specify particular classes 116 to change, add, or delete.

The client 114 retrieves the schema change request form 120 from a forms server 122. One implementation of the forms server 122 is a hypertext markup language (HTML) server. Using an internet browser application, the client 114 can download the schema change request form 120 via a network. Alternatively, the schema change request form 120 can be a text document (e.g., WORD document) that resides on a network drive accessible by the client 114. Exemplary schema change request form questions are shown below:
What is the scope of the schema request?
Do these changes deviate from our stated best practices? (If Yes, please describe)
List the object IDs (OIDs) that are being used.
Do all elements follow company naming recommendations? (If No, please desribe)
Are any attributes indexed? If so, which ones, how will they be initially loaded, and how with they be maintained as widely populated?
Are any attributes being added to a partial attribute set? If so, which ones, how will they be initially loaded, and how will they be maintained as widely populated?
Are there any changes to existing custom elements? (If Yes, please describe)
Are any attributes expected to contain more than 1 MB?
List the owner of this request and the owner's manager.
Has Corporate Security reviewed these changes? (Please provide verification of successful review.
What schema are you planning on extending?
What testing has been done on this extension? (You may be asked to provide supporting documentation)
Does this extension provide similar functionality to existing elements? If so, why are they necessary?
Please provide an LDIF file with all proposed changes.
How are these changes to be loaded? (i.e. LDIF, .EXE)
When should these changes be made to each domain?
Do you require help in developing a schema test plan?

In accordance with one implementation, prior to filling out and submitting the schema change request form, the client 114 is required to test the proposed schema change locally. Testing the schema change locally involves performing steps in a schema change test plan on the client 114 or on several clients in the domain 102a. The IT system 104 can provide a schema test plan or facilitate generating a schema test plan.

After the client 114 successfully tests the proposed schema change and fills out the schema change request form, the client 114 submits the schema change request form 120 to the IT system 104. The schema change request form 120 is typically queued for analysis at a specified date. In accordance with one implementation, the specified date is set to be at least one week from the date that the proposed schema change is submitted.

IT personnel 124 analyze the proposed schema change to determine whether the change should be implemented. This analysis involves consideration of the proposed schema change and the current schema based on schema change criteria 126. Schema change criteria 126 sets forth rules that dictate whether a schema change can, should, must, or must not be implemented. By way of example, but not limitation, schema change criteria 126 include rules as follow:
a proposed change to add a class that already exists in the schema shall be rejected;
a proposed change to a class that conflicts with another class shall be rejected;
a proposed change that is a critical business necessity for continued operation should be approved;
proposed changes that violate corporate policies shall be rejected;
a proposed change that violates a security guideline or corporate guideline should be rejected.

In some cases, multiple clients, including client 114, submit proposed schema changes simultaneously, or relatively close in time, such that the proposed schema changes may be analyzed concurrently by the IT system 104. When this occurs, the IT personnel 124 analyze each proposed schema change with respect to the other proposed schema changes. Thus, for example, the IT personnel 124 determine whether multiple proposed schema changes are in conflict, or are duplicative. In cases where two proposed schema changes are duplicative, only one will be implemented. In cases where two proposed schema changes are in conflict, the IT system 104 typically reject at least one of the proposed changes, with an explanation for the rejection.

If the IT personnel 124 approve a proposed schema change, a change control system 128 is notified of the change. Change control 128 is a group or system that implements the change to the schema 112 in a controlled fashion, typically according to a specified schedule. The client 114 and/or the domain 102a may also be notified of the schema change and when the schema change will occur.

Modules (e.g. schema governance module 118, domain controller 106, client 114) shown in FIG. 1A may be implemented with any of various types of computing devices known in the art, depending on the particular implementation, such as, but not limited to, a desktop computer, a laptop computer, a personal digital assistant (PDA), a handheld computer, or a cellular telephone. The computing devices typically communicate via a network (not shown), which may be wired or wireless.

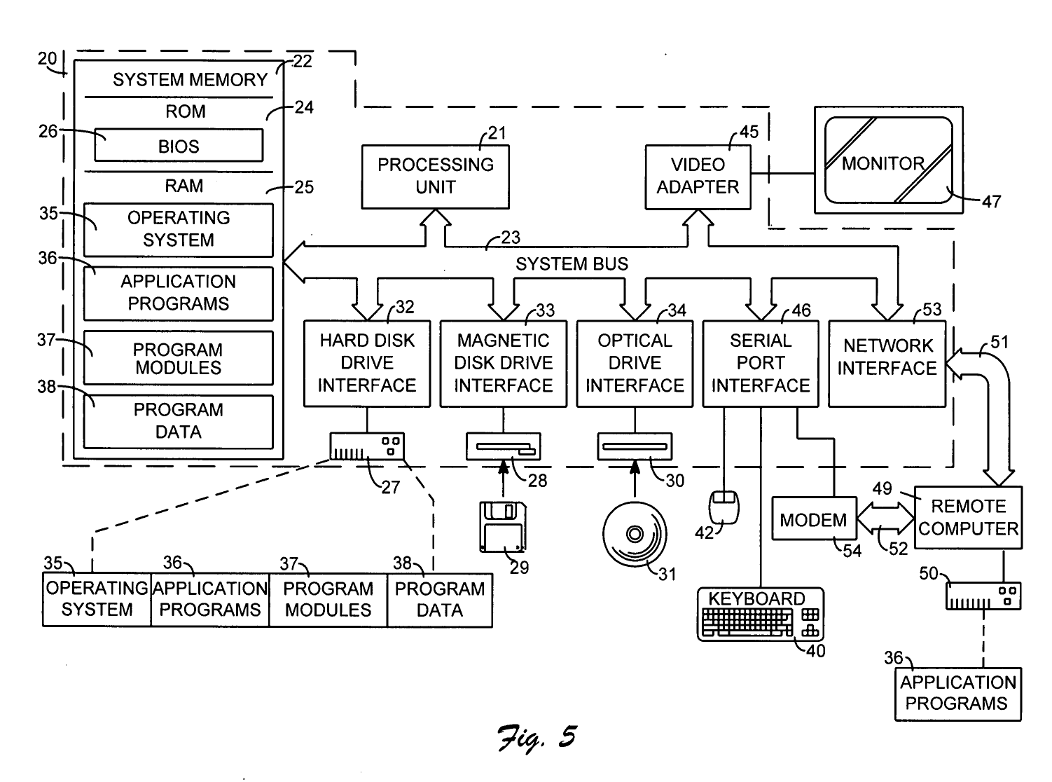

In addition, the computing devices may be arranged in any convenient configuration, such as, but not limited to client/server and peer-to-peer configurations. Modules shown in FIG. 1A can be implemented in software or hardware or any combination of software or hardware. FIG. 5, discussed in detail below, illustrates a computing environment that may be used to implement the computing devices, applications, program modules, networks, processes and data discussed with respect to FIG. 1A.

Exemplary Operations

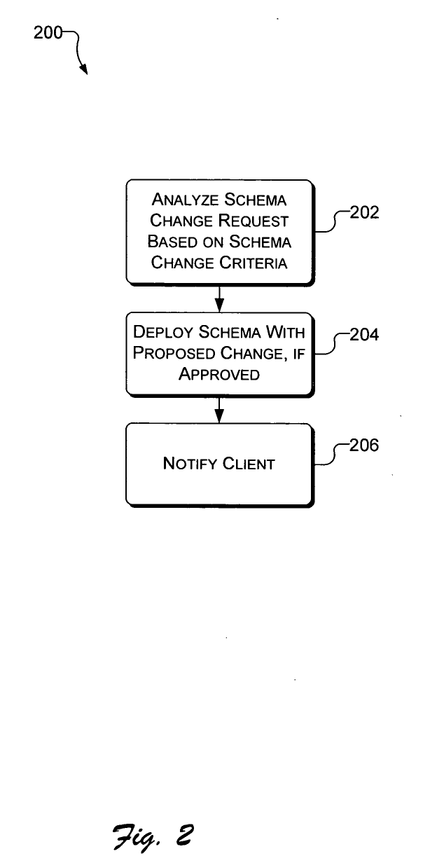

FIG. 2 illustrates an exemplary schema governance algorithm 200 having operations for governing changes to a schema for an identity store. The schema governance algorithm 200 can be performed by the IT system 104 shown in FIG. 1A. Alternatively, the schema governance algorithm 200 can be carried out by systems other than the IT system 104 shown in FIG. 1A. In general, when a schema change request form is submitted, the schema governance algorithm 200 is performed to determine whether to approve or reject the proposed change, and to update and deploy the schema if the change is approved.

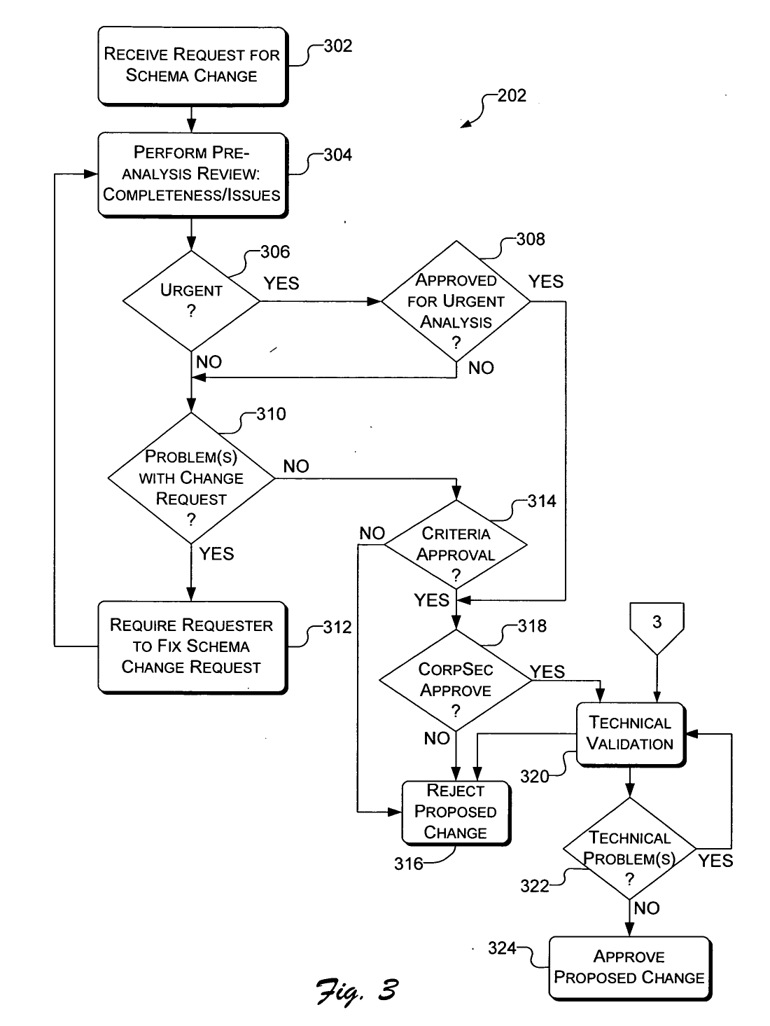

Initially, an analyzing operation 202 analyzes the submitted schema change request based on schema change criteria. As discussed above, the schema change criteria set forth rules for determining whether to approve or reject a proposed schema change. The proposed schema change is analyzed with respect to the existing schema and with respect to other proposed schema changes. FIG. 3, discussed below, illustrates one exemplary implementation of the analyzing operation 202.

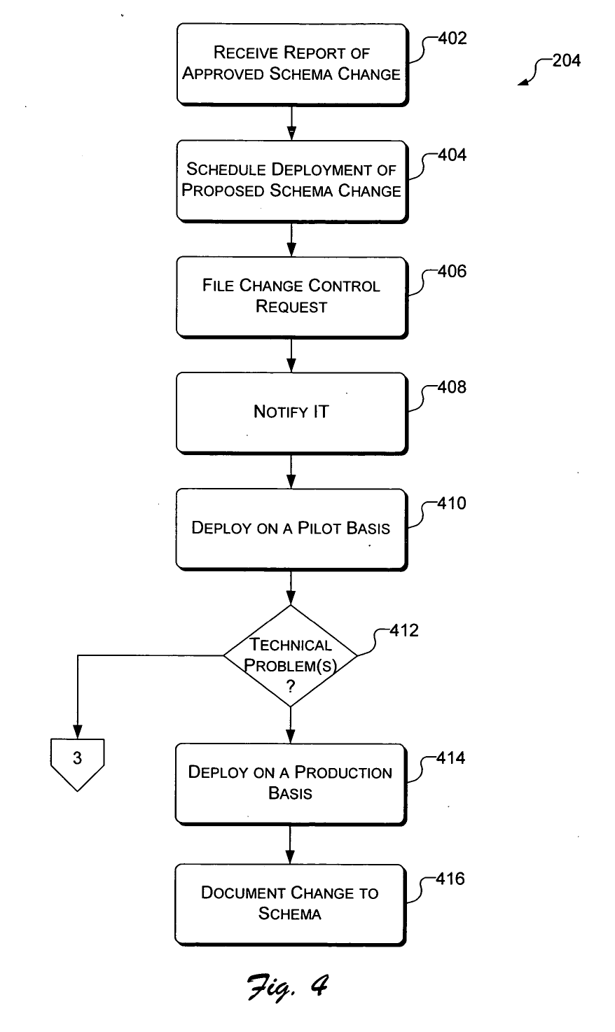

A deploying operation 204 deploys the schema with the proposed change, if the proposed change is approved. A particular implementation of the deploying operation performs a pilot deployment prior to actually deploying the updated schema in the production environment. This allows for a gradual approach to deployment to reduce the likelihood of introducing problems into the identity system that may be difficult to remove. Such an implementation is shown in FIG. 4 and discussed below.

After the proposed schema change is analyzed and deployed, if approved, a notifying operation 206 notifies the requesting client of the results. The notification to the client can include various information, such as, but not limited to, reasons for approval or rejection, date, time, or manner of deployment, or request for other information. FIGS. 3-4 present particular implementations for analyzing the proposed schema change and deploying the proposed schema change, if the change is approved.

FIG. 3 illustrates an exemplary schema change analysis algorithm 202 having operations for analyzing a proposed schema change based on schema change criteria. Initially, a receiving operation 302 receives a schema change request form that describes the change that the client desires. The schema change request form is pre-analyzed in a performing operation 304, which determines whether the request is complete, or if there are any deficiencies, or problems with the request.

A determining operation 306 determines whether the client has requested that the request be analyzed in an expedited manner; i.e., whether the request should be considered urgent. Typically the request form provides a mechanism (e.g., checkbox) for the client to request urgent status. The change request form typically includes a field in which the client can supply reasons or justification for the urgency. If urgent status is requested, the algorithm 202 branches “YES” to an approving operation 308.

The approving operation 308 is typically carried out by a higher-level decision maker, such as a director of the IT group. The approving operation 308 considers the reasons given by the client in support of the requested urgency. The director typically has discretion to determine whether urgent status is justified. If the reasons support a compelling business need or remedy a security issue, then the urgency will typically be justified. Examples of compelling business needs are those that affect a specified number (e.g., fifty) of employees or a result in work stoppage if the proposed change is not implemented.

If the proposed change is not urgent, the analysis algorithm 202 branches to a determining operation 310. The determining operation 310 determines whether the change request has any problems, such as information deficiencies that need to be fixed before the change request can be analyzed. If problems exist, then the algorithm branches “YES” to a requiring operation 312. The requiring operation 312 requests that the client fix the problems with the schema change request, such as, but not limited to, providing additional required information. After the client fixes the problems with the schema change request, the performing operation 304 again performs the pre-analysis.

If no problems are identified in the determining operation 310, the algorithm 202 branches “NO” to another determining operation 314. The determining operation 314 determines whether the proposed schema change is in accordance with schema change criteria. Various schema change criteria are described above with respect to FIG. 1A. Typically IT personnel perform the determining operation 314. The IT personnel apply the schema change criteria to the proposed change. For example, if the schema change duplicates an existing attribute, the proposed change violates the schema change criteria.

In other situations, more judgment is required to determine whether the proposed schema change is in accordance with the schema change criteria. For example, suppose the schema change criteria do not allow any duplicated classes. For purposes of determining whether a proposed new class duplicates an existing class, the functions and descriptions of the classes typically must be analyzed, and not just the names of the classes. The proposed new class may functionally duplicate an existing class, and therefore violate the schema change criteria, even though the class names are different. If the proposed schema change is not in accordance with the schema change criteria, the algorithm branches “NO” to a rejecting operation 316, which rejects the proposed change.

If the determining operation 314 determines that the proposed change is in accordance with the schema change criteria, the algorithm branches “YES” to another determining operation 318. Also, if in the approving operation 308, the proposed change is approved for urgent or expedited status, the algorithm branches “YES” to the determining operation 318. The determining operation 318 determines whether the proposed change creates a security problem or violates any security policies.

If the determining operation 318 determines that the proposed change is in accordance with security policies, the algorithm 202 branches “NO” to the rejecting operation 316. If the determining operation 318 determines that the proposed change is in accordance with security policies, the algorithm 202 branches “YES” to a technical validating operation 320. The technical validating operation 320 checks whether the proposed change to the schema is technically feasible by examining the LDIF file.

Another determining operation 322 determines whether there are any technical problems with the proposed schema change. If technical problems are identified, the determining operation 322 can make adjustments to the proposed schema and validate the schema change again in the validating operation 320. The technical validation operation 320 and the determining operation 322 can reiterate multiple times. After a specified number of iterations, if the validating operation 320 still results in technical problems, the algorithm branches to the rejecting operation 316.

If, during one of the iterations, the determining operation 322 identifies no technical problems with the schema change, the algorithm branches “NO” to an approving operation 324. The approving operation 324 approves the proposed schema change for deployment. The approving operation 324 records that the proposed schema change is approved and provides information, such as the affected domain, which can be used during deployment.

FIG. 4 illustrates an exemplary deployment algorithm 204 having operations for deploying a schema with an approved change. The schema is first deployed in a pilot or experimental deployment. If the pilot deployment works without errors, the schema is deployed on a production basis. Initially, a receiving operation 402 receives a report that identifies the approved schema change. The report includes information relevant to deploying the approved schema change, such as the associated domain or forest, the class or classes to be added, deleted, or changed, or the urgency of the change. A scheduling operation 404 schedules the deployment of the proposed change.

A filing operation 406 files a change control request with the change control group. The change control request initiates the first step in deployment. An exemplary change control request is shown below:

Reference ID: 200407230061887

Subject: Schema Extension: New LCS Attribute for Locked Schema
Service None
Impact:
Acct Mgr
Approval:
Start: Jul. 29, 2004 4:00:00 PM Jul. 29, 2004 11:00:00 PM (GMT)
End: Jul. 29, 2004 4:00:00 PM Jul. 29, 2004 11:00:00 PM (GMT)
Category: ACTIVE DIRECTORY
WorkType: Routine/Project Work
Organizational IdentityManagement (IdM)
Owner:
Change Overview Additional schema modifications are required to
Purpose: continue LCS 2.0 dogfooding efforts in the IT environment. The schema has been ‘locked down’ and we need to implement in our production environment to help meet shared goals and ship criteria. Please review the Schema Package document for this request for complete details. Business Driver LCS 2.0 is deployed in beta form in the corporate environment for dogfooding purposes. The first phase involved creation of new attributes in the AD schema along with MIIS sync logic and changes to our account provisioning system (AccManNG). This schema request is the final ‘locked down’ version that is expected to be shipped with the product when it becomes Generally Available and it needs to be implemented in our production environment to be ready for the RC bits.
Impact: Impact
   This change will be transparent to end users. Continued dog fooding of LCS bits will continue and is dependent on the schema extension.
   Deployment Plan:
      NTDEV—7/29
      WINDEPLOY—8/3
      WINSE & CORP—8/5
         First Contact IdMSchemaPM
Person:
   2nd Contact IdMSchemaTech
Person:

A notifying operation 408 notifies the IT group that the change will be occurring. An example notification is shown below:

From: IdM Schema Management Service

Sent: Friday, Jul. 23, 2004 11:09 AM

To: Schema Virtual Team

Subject: Notice: Schema Modification to NTDEV, WINDEPLOY, WINSE and CORP Forests for LCS Dogfooding

Overview

Additional schema modifications are required to continue LCS 2.0 dogfooding efforts in the corporate IT environment. The schema has been ‘locked down’ and we need to implement in our production environment to help meet shared goals and ship criteria. Please review the Schema Package document for this request for complete details. Implementation of this schema modification is following our published schema process.

Business Driver

LCS 2.0 is deployed in beta form in the corporate environment for dogfooding purposes. The first phase involved creation of new attributes in the AD schema along with MIIS sync logic and changes to our account provisioning system (AccManNG). This schema request is the final ‘locked down’ version that is expected to be shipped with the product when it becomes Generally Available and it needs to be implemented in our production environment to be ready for the RC bits.

Impact

This change will be transparent to end users. Continued dogfooding of LCS bits will continue and is dependent on the schema extension.

Deployment Plan:

1. NTDEV—7/29

2. WINDEPLOY—8/3

3. WINSE & CORP—8/5
Note: Link to complete project schedule available. Change Control link:
http://changecontrol/default.asp?refID=200407230061887
   Support or Questions: Questions may be sent to the mailto:IDMPM team. http://itweb/identity

A deploying operation 410 deploys the approved schema change on an experimental or pilot basis. The schema is updated with the change in a test directory and used for a specified test period (e.g., one week). During this test period, any technical problems are identified. A determining operation 412 determines whether any technical problems exist with the updated schema. If technical problems are identified, the deploying algorithm 204 branches “YES” back to the technical validation operation 320 of the analysis algorithm 202 shown in FIG. 3.

If, after the specified test period no problems have been identified, the pilot deployment ends, and another deploying operation 412 deploys the updated schema on a production basis. In other words, the deploying operation 412 deploys the updated schema such that the updated schema is put into actual use in day-to-day operation.

A documenting operation 414 documents the change to the schema. The documenting operation 414 documents every extension (e.g., added class) made to the schema. In one implementation of the documenting operation 414, a schema documentation program searches a directory based on a specified prefix. The prefix defines a schema extension. A schema prefix and object ID (OID) can be registered using a registration service, such as the ACTIVE DIRECTORY Naming Registration Web page. For every class or attribute that matches the prefix, the program copies information about the class or attribute into an XML file. Data entered into the schema documentation program is stored in a configuration file so that the data can be used again later.

Exemplary Computing Device

With reference to FIG. 5, an exemplary system for implementing the operations described herein includes a general-purpose computing device in the form of a conventional personal computer 20, including a processing unit 21, a system memory 22, and a system bus 23. System bus 23 links together various system components including system memory 22 and processing unit 21. System bus 23 may be any of several types of bus structures including a memory bus or memory controller, a peripheral bus, and a local bus using any of a variety of bus architectures. System memory 22 includes read only memory (ROM) 24 and random access memory (RAM) 25. A basic input/output system 26 (BIOS), containing the basic routine that helps to transfer information between elements within the personal computer 20, such as during start-up, is stored in ROM 24.

As depicted, in this example personal computer 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31 such as a CD ROM, DVD, or other like optical media. Hard disk drive 27, magnetic disk drive 28, and optical disk drive 30 are connected to the system bus 23 by a hard disk drive interface 32, a magnetic disk drive interface 33, and an optical drive interface 34, respectively. These exemplary drives and their associated computer-readable media provide nonvolatile storage of computer readable instructions, data structures, computer programs and other data for the personal computer 20.

Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, random access memories (RAMs), read only memories (ROMs), and the like, may also be used in the exemplary operating environment.

A number of computer programs may be stored on the hard disk, magnetic disk 29, optical disk 31, ROM 24 or RAM 25, including an operating system 35, one or more application programs 36, other programs 37, and program data 38. A user may enter commands and information into the personal computer 20 through input devices such as a keyboard 40 and pointing device 42 (such as a mouse).

Other input devices (not shown) may include a camera, microphone, joystick, game pad, satellite dish, scanner, or the like. These and other input devices are often connected to the processing unit 21 through a serial port interface 46 that is coupled to the system bus, but may be connected by other interfaces, such as a parallel port, game port, a universal serial bus (USB), etc.

A monitor 47 or other type of display device is also connected to the system bus 23 via an interface, such as a video adapter 45. In addition to the monitor, personal computers typically include other peripheral output devices (not shown), such as speakers and printers.

Personal computer 20 may operate in a networked environment using logical connections to one or more remote computers, such as a remote computer 49. Remote computer 49 may be another personal computer, a server, a router, a network PC, a peer device or other common network node, and typically includes many or all of the elements described above relative to the personal computer 20.

The logical connections depicted in FIG. 5 include a local area network (LAN) 51 and a wide area network (WAN) 52. Such networking environments are commonplace in offices, enterprise-wide computer networks, Intranets and the Internet.

When used in a LAN networking environment, personal computer 20 is connected to local network 51 through a network interface or adapter 53. When used in a WAN networking environment, the personal computer 20 typically includes a modem 54 or other means for establishing communications over the wide area network 52, such as the Internet. Modem 54, which may be internal or external, is connected to system bus 23 via the serial port interface 46.

In a networked environment, computer programs depicted relative to personal computer 20, or portions thereof, may be stored in a remote memory storage device. It will be appreciated that the network connections shown are exemplary and other means of establishing a communications link between the computers may be used.

Various modules and techniques may be described herein in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

An implementation of these modules and techniques may be stored on or transmitted across some form of computer-readable media. Computer-readable media can be any available media that can be accessed by a computer. By way of example, and not limitation, computer-readable media may comprise “computer storage media” and “communications media.”

“Computer storage media” includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer-readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

Although the exemplary operating embodiment is described in terms of operational flows in a conventional computer, one skilled in the art will realize that the present invention can be embodied in any platform or environment that processes and/or communicates video signals. Examples include both programmable and non-programmable devices such as hardware having a dedicated purpose such as video conferencing, firmware, semiconductor devices, hand-held computers, palm-sized computers, cellular telephones, and the like.

Although some exemplary methods and systems have been illustrated in the accompanying drawings and described in the foregoing Detailed Description, it will be understood that the methods and systems shown and described are not limited to the particular implementation described herein, but rather are capable of numerous rearrangements, modifications and substitutions without departing from the spirit set forth herein.

What is claimed is:

1. A method of managing an existing schema defining objects in an identity store comprising:
receiving a request specifying a proposed change to the existing schema; and
determining whether to approve the proposed schema change based on schema change criteria.

2. A method as recited in claim 1 wherein the proposed schema change comprises an extension to the existing schema.

3. A method as recited in claim 1 wherein the proposed schema change comprises a deletion of an attribute in the existing schema.

4. A method as in claim 1 wherein determining comprises determining whether the proposed schema change constitutes a duplication of a class in the existing schema.

5. A method as recited in claim 1 further comprising determining whether the proposed schema change constitutes a duplication of a class related to another proposed schema change.

6. A method as recited in claim 1 wherein determining comprises determining whether the proposed schema change conflicts with a class in the existing schema.

7. A method as recited in claim 1 wherein determining comprises determining whether the proposed schema change conflicts with another proposed schema change.

8. A method as recited in claim 1 further comprising providing a schema change request form via a forms server.

9. A method as recited in claim 1 further comprising deploying the proposed schema change if the proposed schema change is approved, wherein deploying comprises:
updating the schema with the proposed schema change;
deploying the updated schema on a pilot basis for a specified period of time;
deploying the updated schema on a production basis after the specified period of time, if no technical problems are detected during the specified period of time.

10. A system comprising:
a schema defining terms for objects in an identity store;
a schema governance module controlling changes to the schema based on schema change criteria.

11. A system as recited in claim 10 further comprising a forms server providing a schema change request form, whereby a user can request a change to the schema.

12. A system as recited in claim 10 wherein the schema change criteria specifies rules dictating whether a proposed schema change should be approved.

13. A system as recited in claim 10 wherein the schema change criteria specifies rules comprising at least one of the following:
a proposed new class shall not duplicate an existing class;
a proposed new class shall not conflict with an existing class;
a proposed new class shall not violate security policies;
a proposed new class shall not violate corporate policies.

14. A system as recited in claim 10 wherein the schema governance module updates the schema based on an approved proposed schema change and deploys the updated schema in an ACTIVE DIRECTORY.

15. A system as recited in claim 10 wherein the schema is stored in a domain and accessible by a domain controller.

16. A system as recited in claim 10 wherein the identity store comprises metadata descriptive of real-world entities.

17. A system for managing changes to a schema defining vocabulary for metadata in an identity store, the system comprising:
a server governance module having schema change criteria specifying rules for determining whether to approve or reject a proposed schema change;
means for generating a schema change request form with which a user can describe a change to a definition related to the metadata.

18. A system as recited in claim 17 wherein the means for generating comprises a hypertext markup language server (HTML).

19. A system as recited in claim 17 wherein the schema change request form is an online form submitted via network by the user.

20. A system as recited in claim 17 wherein the server governance module first deploys an approved proposed schema change in a testing stage and then deploys the approved proposed schema change in production stage, if no technical problems are detected in the testing stage.
